(19) United States
(12) Patent Application Publication
(10) Pub. No.: US 2011/0214105 A1
(43) Pub. Date: Sep. 1, 2011

(54) PROCESS FOR ACCEPTING A NEW BUILD

(76) Inventors: Pavel Macík, Brno (CZ); Lukás Petrovický, Most (CZ)

(21) Appl. No.: 12/713,862

(22) Filed: Feb. 26, 2010

(51) Int. Cl. G06F 11/36

(52) U.S. Cl. 717/124

(57) ABSTRACT

An apparatus and a method for accepting new software build is described. A new software build is received at a computer system. The new software build and a released software build previously stored in the computer system are unpacked. The unpacked new software build is tested against data in each database used by the released software build.

### TECHNICAL FIELD

Embodiments of the present invention relate to computing systems, and more particularly, to a process for accepting a new software build.

### BACKGROUND

In the field of computer software, the term software build refers either to the process of converting source code files into standalone software artifact that can be run on a computer, or the result of doing so. One of the most important steps of a software build is the compilation process where source code files are converted into executable code.

The installation of a new build on a computer system that includes a previously released build may pose some conflict problems where data from the previously release build is incompatible with the new build. Testing a newly released build is conventionally manually performed and can be a time consuming task.

### BRIEF DESCRIPTION OF THE DRAWINGS

The present invention is illustrated by way of example, and not by way of limitation, in the figures of the accompanying drawings and in which:

FIG. 1 is a flow diagram illustrating one embodiment of a method for testing and accepting a build in a computer system.

FIG. 2 is a flow diagram illustrating another embodiment of a method for testing and accepting a build in a computer system.

FIG. 3 is a block diagram illustrating one embodiment of a computer system having a build tester module.

### DETAILED DESCRIPTION

Described herein is an apparatus and a method for accepting new software build. A new software build is received at a computer system. The new software build and a released software build previously stored in the computer system are unpacked. The unpacked new software build is tested against data in each database used by the released software build.

In the field of computer software, the term software build refers either to the process of converting source code files into standalone software artifact that can be run on a computer, or the result of doing so. One of the most important steps of a software build is the compilation process where source code files are converted into executable code. While for simple programs the process consists of a single file being compiled, for complex software the source code may consist of many files and may be combined in different ways to produce many different versions. The present application describes how to automatically accept a new build while ensuring compatibility with a previous build stored on a computer.

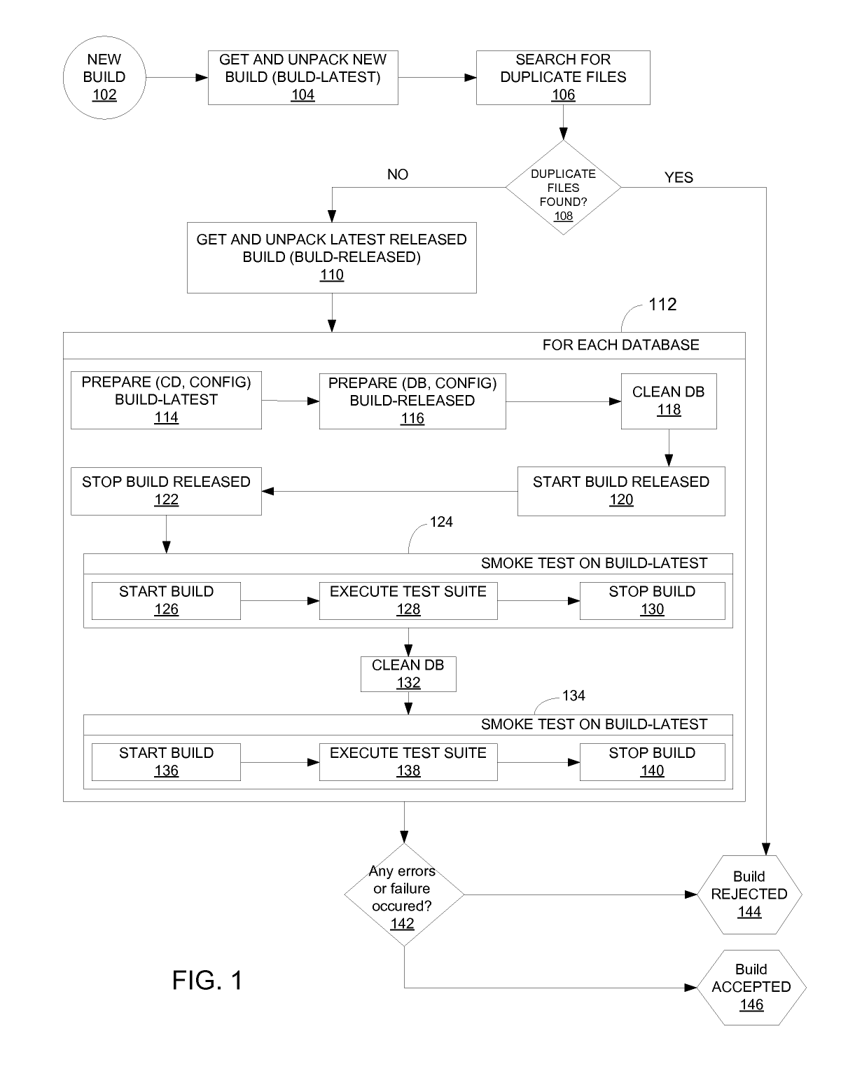

FIG. 1 is a flow diagram illustrating one embodiment of a method for testing and accepting a build in a computer system. At 102, a new build is received at the computer system. There are many ways in which the new build is received, for example, via a network of computer (e.g. the Internet), or an I/O interface such as a USB port or a disk drive. At 104, the new build also referred to as the latest build is unpacked at the computer system. An example of the unpacking process includes decoding or decompressing the new build. At 106, the computer system searches for duplicate files that are already stored in the computer system. If there are any found at 108, the new build is rejected as a duplicate build at 144. If there are no duplicate files already stored on the computer system, a previously released build already stored on the computer system is unpacked at 110.

The following process applies for each database at 112:

At 114, the new build is prepared and configured (e.g. URL, FTP server, etc. . . . ) by configuring each part of the product from the new build against the database. At 116, the previously released build is prepared and configured. At 118, the database from the configured new build and previously released build are cleaned. In other words, any tables, data, procedure of keys needs to come empty. At 120, the computer system starts the previously released build and stops at 122.

At 124, a smoke test is performed on the new build by starting the new build at 126, executing a suite of tests at 128, and stopping the build at 130. In one embodiment, the suite of tests includes a series of tests to test critical feature of the product from the new build. The tests can include tests to determine whether the new product from the new build works against data in the database produced by the previously released build.

At 132, the database is cleaned again. Another smoke test 134 is repeated and performed on the new build. As the in the previous smoke test 124, smoke test 134 is performed on the new build by starting the new build at 136, executing a suite of tests at 138, and stopping the build at 140. In one embodiment, the suite of tests includes a series of tests to test critical feature of the product from the new build.

If there are any error or failure at 142 from smoke tests 124 and 134, the new build is rejected at 144. Otherwise, the new build is accepted at 146.

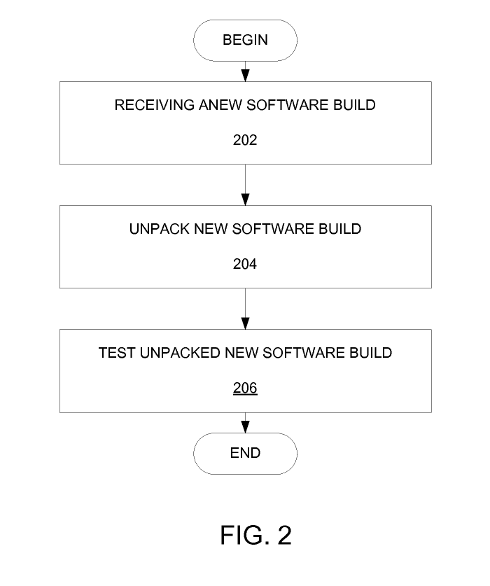

FIG. 2 is a flow diagram illustrating another embodiment of a method for testing and accepting a build in a computer system. At 202, a new software build is received at a computer system. At 204, the new software build and a released software build previously stored in the computer system are unpacked. At 206, the unpacked new software build is tested against data in each database used by the released software build to ensure compatibility.

In one embodiment, the computer system searches for duplicate files of the unpacked new software build and rejects the new software build when duplicate files of the unpacked new software build are already present in the computer system.

In another embodiment, the computer system configures the database used by the new software build, and the database used by the released software build. Both databases are cleaned to ensure that no data are present during the test. The computer system then starts and stops unpacking the new software build.

The computer system performs a series of tests on the new software build, and cleans the database used by the new software build. The unpacked new software build is rejected when the series of tests result in an error. In one embodiment, the series of tests is configured to test critical features of the unpacked new software build against the database used by the released software build. In another embodiment, the unpacked new software build is tested against data in each database used by the released software build in parallel or sequentially.

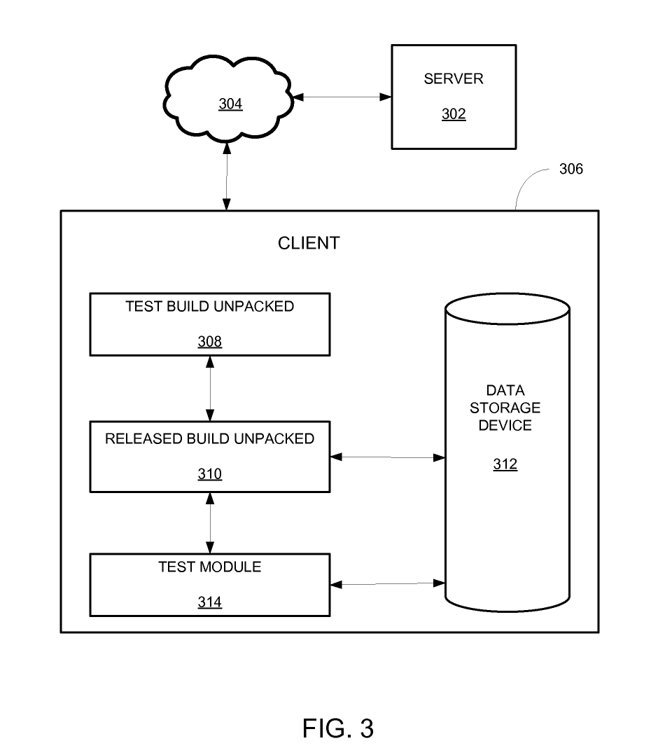

FIG. 3 illustrates a diagrammatic representation of a machine 306 in the exemplary form of a computer system within which a set of instructions, for causing the machine to perform any one or more of the methodologies discussed herein, may be executed. In alternative embodiments, the machine 306 may be connected (e.g., networked) to other machines 302 in a LAN, an intranet, an extranet, or the Internet 304. The machine 306 may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system includes a processing device, a main memory (e.g., read-only memory (ROM), flash memory, dynamic random access memory (DRAM) such as synchronous DRAM (SDRAM), a static memory (e.g., flash memory, static random access memory (SRAM), etc.), and a data storage device 312, which communicate with each other via a bus.

Processing device 316 includes the following modules: a new build unpacker module 308, a released build unpacker module 310, and a test module 314. Processing device 316 represents one or more general-purpose processing devices such as a microprocessor, central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device may also be one or more special-purpose processing devices such as an application specific integrated circuit (ASIC), a field programmable gate array (FPGA), a digital signal processor (DSP), network processor, or the like. The processing device is configured to execute modules 308, 310, and 314 for performing the operations and steps discussed herein with. In one embodiment, modules 308, 310, and 314 may be include hardware or software or a combination of both.

The computer system may further include a network interface device. The computer system also may include a video display unit (e.g., a liquid crystal display (LCD) or a cathode ray tube (CRT)), an alphanumeric input device (e.g., a keyboard), a cursor control device (e.g., a mouse), and a signal generation device (e.g., a speaker).

Data storage device 312 may include a non-transitory computer-accessible storage medium on which is stored one or more sets of instructions embodying any one or more of the methodologies or functions described herein. The software may also reside, completely or at least partially, within the main memory and/or within the processing device during execution thereof by the computer system, the main memory and the processing device also constituting computer-accessible storage media. The software may further be transmitted or received over a network via the network interface device.

The computer-accessible storage medium may also be used to store unpacked new and released builds. While the computer-accessible storage medium is shown in an exemplary embodiment to be a single medium, the term “computer-accessible storage medium” should be taken to include a single medium or multiple media (e.g., a centralized or distributed database, and/or associated caches and servers) that store the one or more sets of instructions. The term “computer-accessible storage medium” shall also be taken to include any medium that is capable of storing, encoding or carrying a set of instructions for execution by the machine and that cause the machine to perform any one or more of the methodologies of the present invention. The term “computer-accessible storage medium” shall accordingly be taken to include, but not be limited to, solid-state memories, optical and magnetic media.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method comprising:
receiving a new software build at a computer system;
unpacking the new software build and a released software build previously stored in the computer system; and
testing the unpacked new software build against data in each database used by the released software build.

2. The computer-implemented method of claim 1 further comprising:
searching for duplicate files of the unpacked new software build at the computer system; and
rejecting the new software build when duplicate files of the unpacked new software build are already present in the computer system.

3. The computer-implemented method of claim 2 further comprising:
configuring the new software build against the database;
configuring the released software build against the database;
cleaning both databases; and
starting and stopping unpacking the new software build.

4. The computer-implemented method of claim 3 further comprising:
performing a series of tests on the new software build; and
cleaning the database used by the new software build.

5. The computer-implemented method of claim 4 further comprising:
rejecting the unpacked new software build when the series of tests result in an error.

6. The computer-implemented method of claim 4 wherein the series of tests is configured to test critical features of the unpacked new software build against the database used by the released software build.

7. The computer-implemented method of claim 1 further comprising:
testing the unpacked new software build against data in each database used by the released software build in parallel or sequentially.

8. A non-transitory computer-readable storage medium, having instructions stored therein, which when executed, cause a computer system to perform a method comprising:
receiving a new software build at a computer system;
unpacking the new software build and a released software build previously stored in the computer system; and
testing the unpacked new software build against data in each database used by the released software build.

9. The non-transitory computer-readable storage medium of claim 8 wherein the method further comprises:
searching for duplicate files of the unpacked new software build at the computer system; and
rejecting the new software build when duplicate files of the unpacked new software build are already present in the computer system.

10. The non-transitory computer-readable storage medium of claim 9 wherein the method further comprises:
configuring the new software build against the database;
configuring the released software build against the database;
cleaning both databases; and
starting and stopping unpacking the new software build.

11. The non-transitory computer-readable storage medium of claim 10 wherein the method further comprises:
performing a series of tests on the new software build; and
cleaning the database used by the new software build.

12. The non-transitory computer-readable storage medium of claim 11 wherein the method further comprises:
rejecting the unpacked new software build when the series of tests result in an error.

13. The non-transitory computer-readable storage medium of claim 11 wherein the series of tests is configured to test critical features of the unpacked new software build against the database used by the released software build.

14. The non-transitory computer-readable storage medium of claim 8 wherein the method further comprises:
testing the unpacked new software build against data in each database used by the released software build in parallel or sequentially.

15. A computer system comprising:
a storage device configured to store a database used by a received new software build and a previously stored released software build; and
a processing device coupled to the storage device, the processing device comprising a new software build unpacker, a released software build unpacker, a test module, the processing device configured to receive the new software build at the computer system,
wherein the new software build packer is configured to unpack the new software build, the released software build unpacker is configured to unpack the previously stored released software build, the test module is configured to test the unpacked new software build against data in each database used by the released software build.

16. The computer system of claim 15 wherein the test module is configured to search for duplicate files of the unpacked new software build at the computer system, and to reject the new software build when duplicate files of the unpacked new software build are already present in the computer system.

17. The computer system of claim 16 wherein the new software build unpacker is configured to configure the new software build against the database, wherein the released software build unpacker is configured to configure the released software build against the database, wherein the new software build unpacker and released software build unpacker are configured to clean their respective database.

18. The computer system of claim 17 wherein the test module is configured to perform a series of tests on the new software build, and to clean the database used by the new software build.

19. The computer system of claim 17 wherein the test module is configured to reject the unpacked new software build when the series of tests result in an error.

20. The computer system of claim 18 wherein the series of tests includes testing of critical features of the unpacked new software build against the database used by the released software build.
